(19) United States
(12) Patent Application Publication
(10) Pub. No.: US 2013/0086612 A1
(43) Pub. Date: Apr. 4, 2013

(54) METHOD FOR PROVIDING MULTIMEDIA CONTENT LIST AND SUB-LIST, AND BROADCAST RECEIVING APPARATUS USING THE SAME

(71) Applicant: Samsung Electronics Co., Ltd., Suwon-si (KR)

(72) Inventors: Ji-eun KIM, Yongin-si (KR); Sung-baik JO, Suwon-si (KR); Ji-hyun PARK, Seoul (KR); Il-kwon KIM, Suwon-si (KR); Joon-hwan KIM, Yongin-si (KR); Hyun-jin KIM, Seoul (KR)

(73) Assignee: SAMSUNG ELECTRONICS CO., LTD., Suwon-si (KR)

(21) Appl. No.: 13/683,897

(22) Filed: Nov. 21, 2012

Related U.S. Application Data
(63) Continuation-in-part of application No. 12/124,568, filed on May 21, 2008.

(30) Foreign Application Priority Data
Nov. 5, 2007 (KR) 10-2007-0112143

(51) Int. Cl. H04N 21/482

(52) U.S. Cl. CPC H04N 21/482
USPC 725/40

(57) ABSTRACT

A broadcast receiving apparatus and method of providing a sub-list thereof are provided. A method of providing a sub-list of the present broadcast receiving apparatus displays a video contents list which contains a plurality of video contents and a sub-list on one screen, selects at least one video content of the plurality of video contents contained in the video content list, and adds the selected at least one video content to the sub-list and displays it.

### CROSS-REFERENCE TO RELATED APPLICATIONS

This application is a Continuation-In-Part of U.S. application Ser. No. 12/124,568 filed May 21, 2008 which claims priority from Korean Patent Application No. 10-2007-0112143, filed on Nov. 5, 2007 in the Korean Intellectual Property Office, the disclosures of which are incorporated herein by reference in their entirety.

### BACKGROUND OF THE INVENTION

1. Field of the Invention

Apparatuses and methods consistent with the present invention relate to providing a multimedia content list and a sub-list, and more particularly, to providing a multimedia content list containing broadcast programs and a list for playback of recorded programs, and a broadcast receiving apparatus which provides the same.

2. Description of the Related Art

In the related art, broadcast program information is generally supplied via newspapers, televisions (TVs) or magazines. However, digital multi-channel broadcasting is provided via scores of channels, so viewers have a choice between a plethora of programs but the task of selecting programs is complicated. Digital multi-channel broadcasting provides an electronic program guide (EPG), which provides program tables or information regarding each program.

Technological developments have enabled TVs to provide a wide range of functions, including receiving and displaying broadcasts.

For example, as a result of the popularization of Internet communications, TVs have come to be provided with access to Internet networks. Accordingly, it becomes possible to use Internet services, such as Internet TV, in TVs. Therefore, users can view video stored in external sources on TVs using the Internet.

TVs are also able to schedule recording of broadcast programs. Accordingly, users can record broadcast programs provided via various channels, and play back the recorded broadcast programs, so a user may view desired broadcast programs at any time.

However, since such multimedia services using TVs are received via various routes, it may be difficult for users to know which programs are available. Additionally, users need to search for each recorded broadcast program separately to play back the program, which causes inconvenience.

Therefore, there is a need for methods by which the user may use TV multimedia content more conveniently.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method for providing a multimedia content list of video files stored in an external device and broadcast programs so that a user can use TV multimedia content more conveniently, and a broadcast receiving apparatus using the method.

The present invention also provides a method for providing a sub-list of programs selected using electronic program guide (EPG) information, and a broadcast receiving apparatus using the method.

According to an aspect of the present invention, there is provided a method of providing a sub-list of a broadcast receiving apparatus which may include displaying a video content list which contains a plurality of video contents and a sub-list, on a screen; selecting at least one of the plurality of video contents contained in the video content list; and adding the selected at least one video content to the sub-list and displaying it.

The video content list may include at least one of a broadcast program list generated using EPG information received from a broadcasting station, a video file list regarding video files stored in an internal storage medium or an external device connected, and a VOD file list regarding VOD files that are received from outside in real time.

If the selecting includes setting a reservation playback time for the selected at least one video content by a user's input; the method may further include playing back the at least one video content contained in the sub-list according to the set reservation playback time

If the video content is a broadcast content, the method may further include recording the selected broadcast content and storing in a record file; and the playing back may play back the record file of the broadcast content at the set reservation playback time

If the video content is a VOD content, the method may further include storing authentication information and route information of the selected VOD content; and the playing back may include receiving the VOD content based on the authentication information and route information of the VOD content at the set reservation playback time; and playing back the received VOD content in real time.

If the video content list is a broadcast program list, the displaying may map the set reservation time of the sub-list with a broadcast time axis of the broadcast program list, and display the sub-list and the broadcast program list on one screen.

If the broadcast receiving apparatus includes a touch panel, the selecting may select at least one video content by a user command of touching a point where a video content to be added to the sub-list is displayed and dragging it to a point where the sub-list is displayed.

The sub-list may differ according to an authenticated user, and the displaying may display the video content list and the sub-list corresponding to the pre-designated user on one screen, if the pre-designated user is authenticated.

According to another aspect of the present invention, there is provided a broadcast receiving apparatus which may include a display unit which displays a video content list which contains a plurality of video contents and a sub-list on one screen; a user input unit; and a controller which, if at least one of the plurality of video contents contained in the video content list is selecte through the user input unit, controls the display unit to add the selected at least one video content to the sub-list and display it.

The video content list may include at least one of a broadcast program list generated using EPG information received from a broadcasting station, a video file list regarding video files stored in an internal storage medium or an external device connected, and a VOD file list regarding VOD files that are received from outside in real time.

If a reservation playback time regarding the selected at least one video content is set using the user input unit, the controller may play back the at least one video content contained in the sub-list according to the set reservation playback time.

The apparatus may further include a storage unit, and when the video content is a broadcast content, the controller may record the selected broadcast content and store it in the storage unit as a record file, and play back the record file of the broadcast content at the set reservation playback time.

The apparatus may further include a storage unit, and, if the video content is a VOD content, the controller may store authentication information and route information of the selected VOD content in the storage unit, and play back the VOD content based on the authentication information and route information of the VOD content at the set reservation playback time.

If the video content list is a broadcast program list, the display unit may map the set reservation time of the sub-list with a broadcast time axis of the broadcast program list, and display the sub list and broadcast list on one screen.

If the user input unit is a touch panel, the controller may select at least one video content by a user command of touching a point where a video content to be added to the sub-list and drag to the point where the sub list is displayed.

The sub list may differ according to an authenticated user, and if a pre-designated user is authenticated, the controller may control the display unit to display the video content list and the sub list corresponding to the predesignated user on one screen.

According to an aspect of the present invention, there is provided a method of providing a sub list which may include displaying a video content list which contains a plurality of video contents; selecting at least one of the plurality of video contents contained in the video content list; and displaying a sub-list where the selected at least one video content is contained, and the video content list and the sub list may be displayed on one screen.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a schematic view of a TV system according to an exemplary embodiment of the present invention;

FIG. 2 is a detailed block diagram of a TV shown in FIG. 1;

FIG. 3 is a flowchart explaining a method for providing a multimedia content list, according to an exemplary embodiment of the present invention;

FIG. 4 is a flowchart explaining a method for providing a sub-list to play back a recorded program, according to another exemplary embodiment of the present invention;

FIG. 5 is a diagram of a multimedia content list according to an exemplary embodiment of the present invention;

FIG. 6 is a diagram of sub-lists displayed for each playback time of recorded program files, according to another exemplary embodiment of the present invention; and

FIG. 7 to FIG. 10 are views illustrating a multimedia content list and a sub-list displayed on one screen according to various exemplary embodiments of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

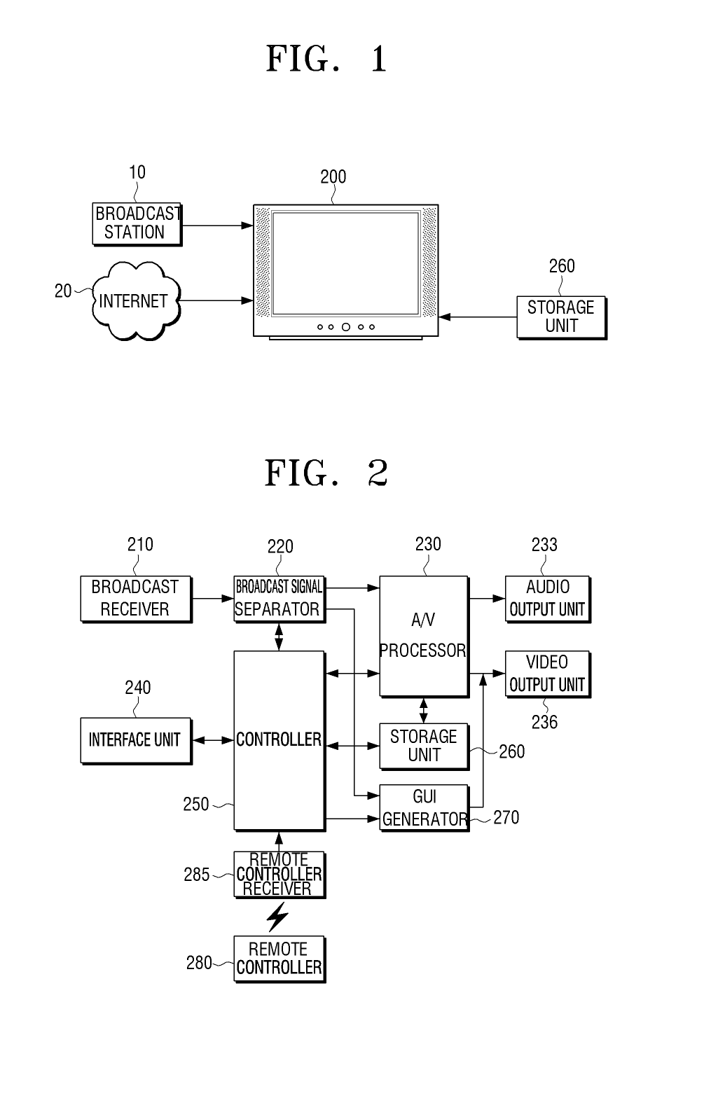

FIG. 1 is a schematic view of a TV system according to an exemplary embodiment of the present invention. In the TV system of FIG. 1, multimedia content may be provided from a storage unit (not shown) in a TV 200, a broadcast station 10 which transmits broadcast signals, and the Internet 20.

The TV 200 may receive the broadcast signals from the broadcast station 10, and display the received broadcast signals. Additionally, the TV 200 may receive EPG information from the broadcast station 10, and generate a broadcast program list based on the EPG information.

In addition, the TV 200 may receive a broadcast program list generated by a user from an external device (for example, smart-phone, tablet PC, server, etc.) and generate a broadcast program list based on the received broadcast program list.

The TV 200 may download a video file from the Internet 20, or may download real time streams in order to play back video. The TV 200 may play back video files stored in the storage unit (not shown) in the TV 200.

Accordingly, a user may be provided with TV multimedia content via various routes.

Hereinafter, the configuration of the TV 200 will be described in detail with reference to FIG. 2. FIG. 2 is a detailed block diagram of the TV 200 shown in FIG. 1.

The TV 200 of FIG. 2 comprises a broadcast receiver 210, a broadcast signal separator 220, an audio/video (A/V) processor 230, an audio output unit 233, a video output unit 236, an interface unit 240, a controller 250, a storage unit 260, a graphical user interface (GUI) generator 270, a remote controller receiver 285 and a remote controller 280.

The broadcast receiver 210 receives a broadcast from a broadcast station or a satellite via a cable or wirelessly, and demodulates the received broadcast. The broadcast receiver 210 may comprise a plurality of tuners (not shown) in order to simultaneously receive broadcast signals through a plurality of channels.

The broadcast signal separator 220 separates the broadcast signal output from the broadcast receiver 210 into a video signal, an audio signal and EPG information. The broadcast signal separator 220 transmits the video signal and audio signal to the A/V processor 230, and the EPG information signal to the GUI generator 270.

The A/V processor 230 performs signal processing, such as video decoding, video scaling, audio decoding or the like, with respect to video and audio signals output from the broadcast signal separator 220 and the interface unit 240. Additionally, the A/V processor 230 transmits the video signal and the audio signal to the video output unit 236 and the audio output unit 233, respectively.

Alternatively, if the video and audio signal are stored in the storage unit 260, or transmitted to an external device via the interface unit 240, the A/V processor 230 outputs the video and audio signal in compressed format to the storage unit 260 or to the interface 240.

The audio output unit 233 may output the audio signal transmitted from the A/V processor 230 through a speaker, or may output the audio signal to an external device (for example, an external speaker) which is connected through an external output terminal.

The video output unit 236 may display the video output from the A/V processor 230 on the display, or may output the video to an external device (for example, an external display) which is connected through an external output terminal.

The interface unit 240 may connect the TV 200 to the Internet 20. Additionally, the interface unit 240 may receive video files from the Internet 20, and may transmit the received video files to the controller 250.

Also, the interface unit 240 may connect the TV 200 to an external mobile device (for example, smart-phone, tablet PC, etc.). Particularly, the interface unit 260 transmits a broadcast program list received from an external mobile device to the controller 250.

The storage unit 260 may record the broadcast program received by the broadcast receiver 210, and store the recorded broadcast program as a recorded program file that is a video file. The storage unit 260 may also store a video file copied by the user. Additionally, the storage unit 260 may output the video files stored therein to the A/V processor 230. The storage unit 260 may be a hard disk drive (HDD), a nonvolatile memory or USB.

In addition, the storage unit 260 stores reservation information on broadcast programs and contents that users reserved. In more detail, the storage unit 260 may store content information about broadcast programs and contents, such as a title of content, playback time, and summary of program etc. Also, the storage unit 260 may store route information such as server information that offers content, channel information, and web information. And, the storage unit 260 may store user information such as a log-in user's ID when a specific user logs in and generates schedule information. Further, the storage unit 260 may store authentication information of premium contents when a user generates reservation information of premium content VOD. And the storage unit 260 may store reservation time information such as a playback reservation time of a broadcast program and content. Also, the storage unit 260 may store content viewing restriction information such as viewer rating of a broadcast program and content that the user reserved.

The GUI generator 270 may generate a GUI to be shown on a screen of the TV 200, and add the generated GUI to video output from the A/V processor 230. The GUI generator 270 may receive EPG information and generate a GUI for showing broadcast program information using the received EPG information.

The remote controller 280 may receive commands input by a user and transmit the received user commands to the TV 200 via the remote controller receiver 285. The user may select a program which he or she desires to schedule for recording, and also may set the playback time to play back the recorded program file, using the remote controller 280.

The controller 250 may recognize user commands input by the user transferred from the remote controller 280, and control the entire operation of the TV 200 in response to the user commands.

The controller 250 may generate a broadcast program list using the EPG information received from the broadcast station 10 or an external device Additionally, the controller 250 may extract a video file list of video files, which are stored in the storage unit 260 or in an external device connected to the TV via the Internet 20. Furthermore, the controller 250 may control the GUI generator 270 to generate a GUI indicating a multimedia content list comprising the generated broadcast program list and the extracted video file list.

Here, the broadcast program list comprises information regarding the title, broadcast time and contents of broadcast programs transmitted from the broadcast station 10. Such information regarding the broadcast program is contained in the EPG information transmitted from the broadcast station 10.

The video file list may include a list of video files stored in the storage unit 260 of the TV 200, or include a list of video files stored in the external device (for example, a web server or a file server) which is connected to the TV 200 via the Internet 20.

Additionally, the video file list may also include video files stored in an external device connected to the TV 200 via communication networks other than the Internet 20. For example, video files stored in a computer connected via a local area network (LAN) or a wide area network (WAN) may be contained in the video file list.

In addition, the video file list may include a VOD (video on demand) file list that offers a desired image whenever a user needs the image. In this case, a VOD file may include at least one of a VOD file that streams video from a general server in real time, a VOD file that streams video from the user's other devices in real time, and a VOD file that the content provider offers through a premium content platform.

When the video file list is displayed, each external device or storage medium in the external device may be listed separately in the video file list. Alternatively, the built-in storage media or the connected external devices may be listed collectively in the video file list.

If the external device is connected via the Internet 20, the video file list may be displayed so that each list item may refer to each web site.

The controller 250 may receive a user's selection of programs from the generated broadcast program list, the video file list and generate one or more sub-lists containing the selected programs and contents. Additionally, the controller 250 may cause the sub-lists and the programs, and contents in the sub-lists to be displayed on the screen of the TV 200.

The sub-list refers to a sub-list from the broadcast program list and a video file list wherein the broadcast programs and contents selected by the user from the broadcast program list and the video file list are arranged according to channels optionally set by the user. Since the sub-list includes the broadcast programs and contents selected by the user, the sub-list may function as a list of user's channels. In more detail, if the user selects programs or contents to be included in the sub-list and sets the playback time of the selected programs or selected contents, the controller 250 may cause the recorded program files containing the programs to be played back at the set playback time. Accordingly, the user can view video played back on the channel set by the user without any further manipulation.

Particularly, the controller 250 may generate and store a sub-list for each user. In this case, the controller 250 may generate the sub-list via a user authentication process to generate and store the sub-list for each user. Specifically, in a case of generating the sub-list, when a user ID and password are input through a remote control, the controller 250 may authenticate the user corresponding to the user ID, and generate and store the sub-list for the authenticated user.

In addition, the controller 250 may transmit sub-list information to other users by a user's input, and reflect sub-list information received from other users to his/her own sub-list information.

GUIs representing sub-lists may have the same form as or a similar form to a GUI representing a broadcast program list. In other words, programs selected by a user are displayed according to the user's selected list of channels and playback time of the selected programs in the sub-lists, in the same manner as broadcast programs are arranged according to the channel and broadcast time in the broadcast program lists.

And, the controller 250 controls the sub-lists as well as programs and contents included in each sub-list to be displayed sequentially according to a set playback time.

Especially, if a program is selected among the broadcast program list, the controller 250 controls a storage unit 260 to record the programs broadcasted and store the recorded programs in a record file, when the selected programs are broadcasted. For example, the controller 250 may store the record files in HDD, flash memory, USB memory etc. Or, the controller 250 may record broadcasted programs and transmit the record files to an external device (for example, PC, STB) connected to a TV through a network, or an external cloud server when the selected programs are broadcasted.

And, if a reservation playback time of the selected program is set, the controller 250 controls the record files of the program to playback at the reservation playback time. On the other hand, the controller 250 automatically sets the time that is unassigned as a reservation playback time, to a reservation playback time, in a case of a program for which a particular reservation playback time has not been input by the user. And, this set reservation playback time may obviously be changed by the user.

According to the control of the controller 250, the sub-lists and programs contained in each sub-list may be caused to appear on the screen in the order of the viewing frequency of the programs in the sub-lists or in the order of the number of programs in the sub-lists. Additionally, the controller 250 may cause the sub-lists to be displayed in the order of the current viewing rate of the programs in the sub-lists or in an order set by the user.

In addition, if a content of a video file list is selected, the controller 250 stores content reservation information. Herein, general content information such as a title of content and playback time, route information (for example, URL address) to access to a content, user information and reservation playback time information may be stored in content reservation information. Especially, if the content is a VOD file which needs user authentication, the controller 250 may store the VOD file with user authentication information. Herein, the user authentication information may be one of user ID and password information that were input during generating a sub-list, user ID and password information that were input during reserving a VOD file, and the user's previously stored mobile information.

And, if a reservation playback time of selected content is set, the controller 250 plays back a content using the stored reservation information at the reservation playback time. Specifically, if the selected content is a content that is stored in an internal or external device, the controller 250 accesses the content stored at the reservation playback time and provides it to a user. Also, if the selected content is a VOD file, the controller 250 may stream the VOD file in real time using route information and authentication information at the reservation playback time and provide it to the user.

On the other hand, in a case of a content for which a reservation playback time has not been input by the user, the controller 250 sets time unassigned as reservation playback time as reservation playback time automatically. And, this reservation playback time may obviously be changed by the user.

On the other hand, in the aforementioned exemplary embodiment, it was explained that after a program or content is selected, the selected program or content is played back at the reservation playback time set by the user. However, this is merely an exemplary embodiment, and if the user selected a channel, the exemplary embodiment that automatically plays back the channel at the reservation playback time set by the user, may also be included in the technical thoughts of the present invention.

For example, if a user wants to display a specific channel (for example, children channel) at a specific time (for example, afternoon), the user may select the specific channel and set to display only the specific channel at the reservation playback time.

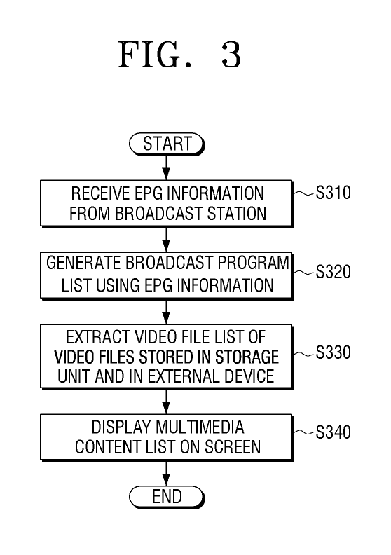

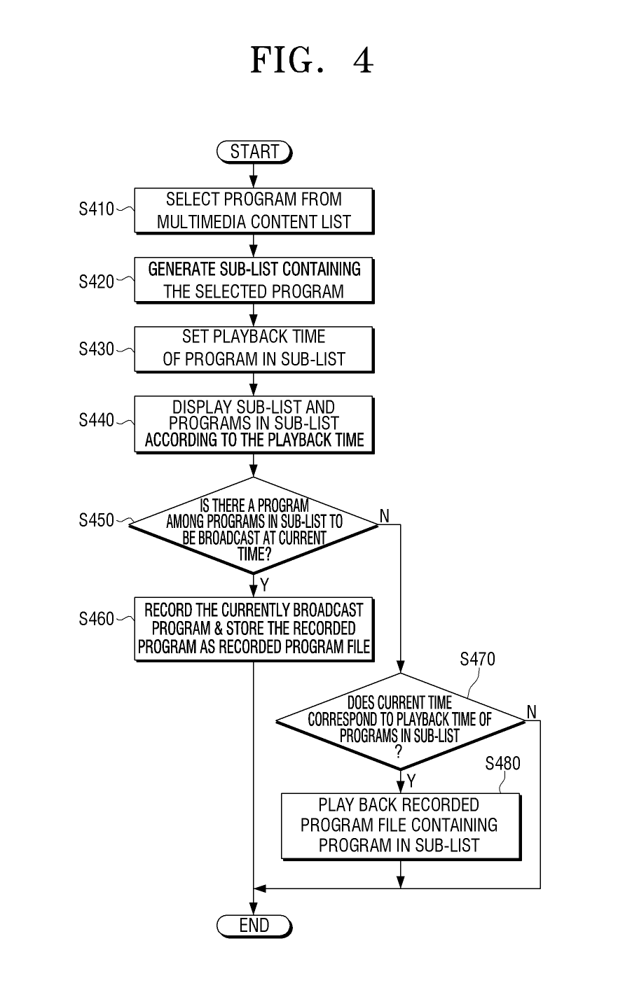

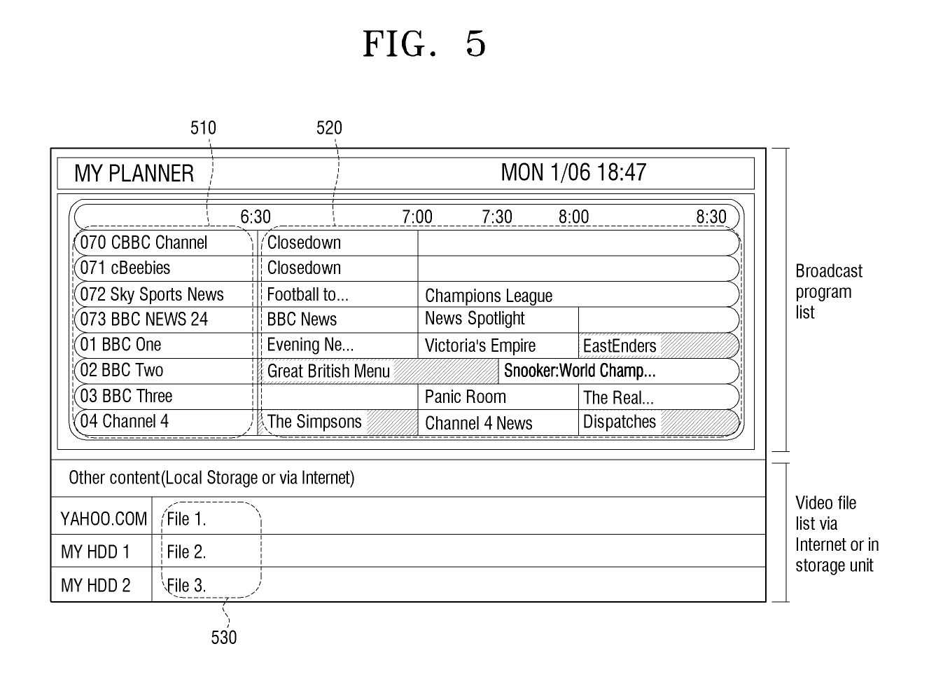

Hereinafter, operations of the controller 250 will be described in detail with reference to FIGS. 3 and 4. FIG. 3 is a flowchart explaining a method for providing a multimedia content list, according to an exemplary embodiment of the present invention.

The broadcast receiver 210 receives EPG information from the broadcast station 10 (operation S310). In more detail, the broadcast receiver 210 receives a broadcast signal from the broadcast station 10, and the broadcast signal separator 220 then separates the EPG information from the broadcast signal and transmits the separated EPG information to the controller 250.

The controller 250 then controls the GUI generator 270 to generate a broadcast program list using the received EPG information (operation S320).

The controller 250 extracts a video file list of video files stored in the storage unit 260 or in the external device connected to the TV 200 via the interface unit 240 (operation S330).

The controller 250 selects at least one file among the video files stored in the storage unit 260, and adds the selected files to the video file list. In this situation, the controller 250 may cause a video file with the highest viewing frequency or a video file selected by the user to be selected from the storage unit 260 and added to the video file list.

Additionally, the controller 250 may add video files stored in an external device connected to the Internet 20 via the interface unit 240 to the video file list. Here, the controller 250 may cause video files freely provided from each web site or video files recommended by web sites to be added to the video file list.

In addition, the controller 250 may add a VOD file that provides video that a user needs at a specific time, to a video file list. In this case, the controller 250 may control to add at least one of a VOD file that streams video from the server in real time, a VOD file that streams video from the user's other devices in real time, and a VOD file that a content provider provides through a premium content platform, to the video file list.

The controller 250 may also add video files stored in an external device connected via communication networks other than the Internet 20 to the video file list. For example, the controller 250 may add video files stored in a computer connected to the TV 200 via a home network to the video file list.

The controller 250 may cause a multimedia content list including a combination of the broadcast program list and the extracted video file list to be displayed on the screen (operation S340). Accordingly, the user can check not only the broadcast program list but also the video file list of the external device using the multimedia content list, so it is possible to select multimedia content more conveniently.

Hereinafter, a sub-list of recorded programs arranged in the order of the playback time will be described in detail with reference to FIG. 4. FIG. 4 is a flowchart explaining a method for providing a sub-list to play back recorded programs, according to another exemplary embodiment of the present invention.

The controller 250 receives a user selection of a program from the multimedia content list (operation S410). In more detail, the user may select a program from the multimedia content list using the remote controller 280 while the multimedia content list is displayed on the screen.

The controller 250 generates a sub-list containing the selected program (operation S420). Here, the user may select programs which the user desires to schedule for recording and view later, and the controller 250 may then make a list of the programs selected by the user as a sub-list.

The controller 250 may set the playback time of the programs contained in the sub-list (operation S430). Specifically, after selecting the programs, the user may set the time to play back the recorded programs. However, if the user does not set the playback time, the controller 250 may set an unassigned time to be the playback time of the selected programs.

The controller 250 may then display the sub-list and the programs contained in the sub-list according to the playback time on the screen (operation S440). In other words, the controller 250 may display the programs scheduled for recording by the user in the order of the time that the programs are to be played back.

The controller 250 determines whether there is a program to be broadcast at the current time from among the programs in each sub-list (operation S450). If it is determined that a currently broadcast program exists (operation 5450-Y), the controller 250 may control the storage unit 260 to record the currently broadcast program and store the recorded program as a recorded program file (operation S460). Further, the controller 250 may transmit and store a record file to either of an external device (for example, STB, PC) or a cloud server.

Alternatively, if it is determined that there is no currently broadcast program from among the programs in the sub-list (operation S450-N), the controller 250 may determine whether the current time corresponds to the playback time of the programs in the sub-list (operation S470).

If it is determined that there is a program to be played back at the current time (operation 5470-Y), the controller 250 may play back the recorded program file containing the program (operation S480).

The user may thereby select a program from the multimedia content list in order to schedule recording of the selected program, and the selected program along with its playback time may then be registered in the sub-list.

Accordingly, after scheduling recording of a desired program, the user may be provided with his own channel so that the desired program can be automatically played back at a desired time.

Although the user may select only the broadcast programs from the multimedia content list in this exemplary embodiment of the present invention, the user may also select video files from the video file list.

In more detail, the controller 250 has a content selected by a user from the multimedia content list. That is, the user may select the content contained in the video file list using a remote controller 280 while the multimedia content list is shown on the screen.

The controller 250 generates a sub-list that contains the selected content. And the controller 250 makes the content selected by the user to be a list in a form of a sub-list. In this case, the sub-list may include not only contents, but also broadcast programs.

In addition, the controller 250 sets the reservation playback time of the content contained in the sub-list. It means that the user may set the playback time of content after selecting the content. However, if the user has not set the reservation playback time, the controller 250 may set the reservation playback time unassigned as the reservation playback time as the reservation playback time of the selected content.

After that, the controller 250 displays the sub-list, programs and contents contained in the sub-list on a screen according to the reservation playback time. That is, the controller 250 displays program and contents that the user reserved sequentially according to the reservation playback time.

The controller 250 decides whether the present time is a reservation time of the content included in the sub-list or not. If there exists a content of which the present time is the reservation playback time, the controller 250 plays back the content using the content's reservation information corresponding to the reservation playback time. In more detail, if the selected content is stored in an internal or external device, the controller 250 accesses the contents stored at the reservation playback time and provides it to the user. Also, if the selected content is a VOD file, the controller 250 may provide the VOD file in real time streaming using the route information and authentication information at the reservation playback time.

Therefore, the user may be provided with his/her own channel which may automatically playback a specific content at a specific time.

The processes of providing the multimedia content list and sub-list according to the operations of the controller 250 have been described with reference to FIGS. 3 and 4.

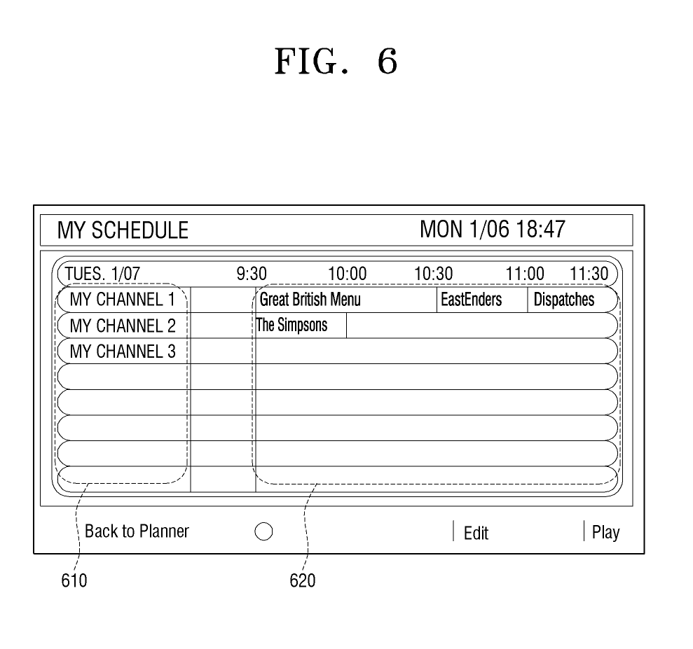

Hereinafter, the configuration of the multimedia content list and the sub-list will be described in detail with reference to FIGS. 5 and 6. FIG. 5 shows the configuration of the multimedia content list according to an exemplary embodiment of the present invention.

The multimedia content list of FIG. 5 is named “MY PLANNER”. The multimedia content list is configured using the EPG information.

The multimedia content list is divided into a channel display field 510, a program display field 520 and a video file list display field 530.

The channel display field 510 and program display field 520 of FIG. 5 relate to the broadcast program list.

The channel display field 510 shows numbers and names of channels, and the program display field 520 displays various programs according to channels and time slots. For example, as shown in FIG. 5, “Evening Ne . . . ” will be broadcast on channel “01 BBC One” between 6:30 to 7:00.

The video file list display field 530 shows a video file list of video files provided via the Internet 20 or stored in the storage unit 260. Referring to FIG. 5, File 1 is provided from “YAHOO.COM” via the Internet 20. Additionally, File 2 is provided from “MY HDD 1”, which is a built-in storage device, and File 3 is provided from “MY HDD 2”.

In the video file list display field 530 of FIG. 5, each list item may refer to each web site or storage device, in the same manner that each program corresponds to a respective channel. Alternatively, each list item may generally indicate the Internet or to all the storage devices.

Accordingly, the user may check both the broadcast program list and video file list at once, and it is thus possible to select content with greater convenience.

If the user selects a desired channel, only the selected channel and program corresponding to the selected channel may appear on the channel display field 510 and program display field 520. Additionally, the channels may be arranged in the order of the viewing frequency of the channels, in the order of the current viewing rate of the channels, in the order of the number of programs selected by the user, or in an order set by the user.

To achieve this, the controller 250 may control the storage unit 260 to store information regarding the viewing frequency for each channel and the period of viewing time. The controller 250 may then determine the order of the viewing frequency of the channels and the order of the current viewing rate of the channels, based on the information stored in the storage unit 260.

The channel display field 510 and program display field 520 may include a menu to automatically recommend a frequently viewed channel. In more detail, the controller 250 may control the viewing frequency to be recorded for each channel so that the channel with the highest viewing frequency may be recommended to be a frequently viewed channel.

Additionally, the channel display field 510 and program display field 520 may provide an automatic view function for automatically displaying important programs or broadcasts of special events, such as a soccer game or news, which the user intends to view at the broadcast time. When the current time reaches the broadcast time of a program for which the automatic view function is established, the controller 250 may change the current channel to the channel on which the program for which the automatic view function is established is to be broadcast, even when the user is currently viewing a broadcast on another channel. Alternatively, the controller 250 may cause a message to be displayed to notify that the program for which the automatic view function is established is about to be broadcast, instead of changing the current channel to the channel corresponding to the program for which the automatic view function is established.

The user may select a program from the broadcast program list of FIG. 5 in order to schedule recording of the selected program. Highlighted programs of FIG. 5 indicate programs selected to be scheduled for recording. In other words, “EastEnders”, “Great British Menu”, “The Simpsons” and “Dispatches” selected by the user may be scheduled for recording. The selected programs may be automatically recorded at their respective broadcast times, and stored as recorded program files in the storage unit 260. Additionally, the recorded program files may be added to sub-lists of a list “MY SCHEDULE” shown in FIG. 6.

The controller 250 may provide a function of displaying only the selected programs. Here, the selected programs may be arranged in the broadcast time order. Additionally, the controller 250 may automatically arrange the selected programs so that the selected programs may be displayed together with other programs in the same series as the selected programs. The controller 250 may also cause subsequent episodes of the selected programs to be automatically recommended.

In order to record programs broadcast on other channels in the same time slot, the broadcast receiver 210 may need to include more than two tuners. For example, in order to record both “Great British Menu” and “The Simpsons” in the same time slot, the broadcast receiver 210 should include at least two tuners.

Accordingly, if the broadcast receiver 210 includes N tuners, and if more than N programs in the same time slot are selected to schedule for recording, the controller 250 may provide a feedback message to notify that it is impossible to select more than N programs in the same time slot. Additionally, under the control of the controller 250, the same program (for example, a rebroadcast program) in other time slots may be recommended along with the feedback message.

Accordingly, the programs selected by the user may be added to the sub-lists of the list “MY SCHEDULE”. Hereinafter, the sub-lists displayed on the screen will be described in detail with reference to FIG. 6. FIG. 6 shows the configuration of the screen which displays the sub-lists for each playback time of recorded program files, according to another exemplary embodiment of the present invention.

As shown in FIG. 6, the list “MY SCHEDULE” comprises a sub-list name display field 610 and a program display field 620. The current date and time as 6:47, Jan. 6, 2008, may be shown at the top of the right-hand edge of the screen. Additionally, the playback date and time of programs in currently displayed sub-lists may appear above the sub-list name display field 610. For example, as shown in FIG. 6, a recorded program file containing “Great British Menu” may be played back between 9:30 and 10:30, Jan. 7, 2008, on “MY CHANNEL 1”.

GUIs representing the sub-lists of FIG. 6 may have the same form as or a similar form to the GUI representing the broadcast program list of FIG. 5. In other words, the sub-list name display field 610 and program display field 620 are displayed according to the playback time in the sub-lists of FIG. 6, in the same manner as that the channel display field 510 and program display field 520 are displayed according to the broadcast time in the broadcast program list of FIG. 5. Accordingly, GUIs showing sub-lists may have the same form as GUIs showing broadcast program lists, so the user can easily use the sub-lists in such a manner that he or she usually uses EPG information.

Since four programs, namely “EastEnders”, “Great British Menu”, “The Simpsons” and “Dispatches”, are selected from the broadcast program list of FIG. 5, the list “MY SCHEDULE” of FIG. 6 includes these four programs.

The sub-list name display field 610 shows the name of sub-lists. For example, the sub-lists may be named as “MY CHANNEL 1”, “MY CHANNEL 2” and “MY CHANNEL 3”. Accordingly, the sub-lists may function as personal channels on which the playback time of the recorded programs is set by the user.

The program display field 620 displays the selected programs according to their playback time slots. The playback times of the selected programs may be set by the user, or if the user does not set a playback time, the controller 250 may cause the selected programs to be automatically broadcast in empty time slots, that is unassigned time slots.

The user may edit a sub-list of programs currently being played back and the playback time of programs in the program display field 620. For example, if the user clicks on “EastEnders” and drags “EastEnders” to a time slot between 11:00 and 11:30 of “MY CHANNEL 3”, “EastEnders” may be set to be played back on “MY CHANNEL 3” between 11:00 and 11:30.

Additionally, the user may add sub-lists, and change the display order of the sub-lists. For example, the sub-lists and the programs contained in each of the sub-lists may be displayed in the order of the viewing frequency of the programs in the sub-lists or in the order of the number of programs in the sub-lists.

A process by which the user selects a program to be recorded and registers the selected program in the list “MY SCHEDULE” is exemplarily described with reference to FIGS. 5 and 6. If the user selects “EastEnders” from the program display field 520 of FIG. 5, a window may be displayed which enables the user to input the playback time and name of a sub-list for the recorded episode of “EastEnders”. Here, the user may input “MY CHANNEL 1” and “between 10:30 and 11:00 on Tuesday, Jan. 7, 2008”. Accordingly, “EastEnders” may be registered to be played back on “MY CHANNEL 1” between 10:30 and 11:00 on Tuesday, Jan. 7, 2008.

The user may thereby create a sub-list so that a program scheduled for recording may be played back in a desired time slot. Additionally, the user can view the program scheduled for recording at the desired time slot more conveniently.

Although only the broadcast programs are selected from the broadcast program list of FIG. 5 in this exemplary embodiment of the present invention, it is also possible to select broadcast programs from the video file list which is provided by the Internet or stored in the storage unit. For example, if the user selects File 1 and sets the playback time to be between 9:30 and 10:00 on “MY CHANNEL 3”, the set playback time may be registered on the list “MY SCHEDULE”. Additionally, the controller 250 may download File 1 from “YAHOO. COM” or download real time streams, and set File 1 to be played back at 9:30, Jan. 7, 2008.

Additionally, the multimedia content list is displayed on the TV 200 in this exemplary embodiment of the present invention, but the present invention is applicable to any broadcast receiving apparatus capable of receiving broadcasts instead of the TV 200. Besides the TV 200, the broadcast receiving apparatuses may be a mobile phone or a navigation device having a broadcast receiving function.

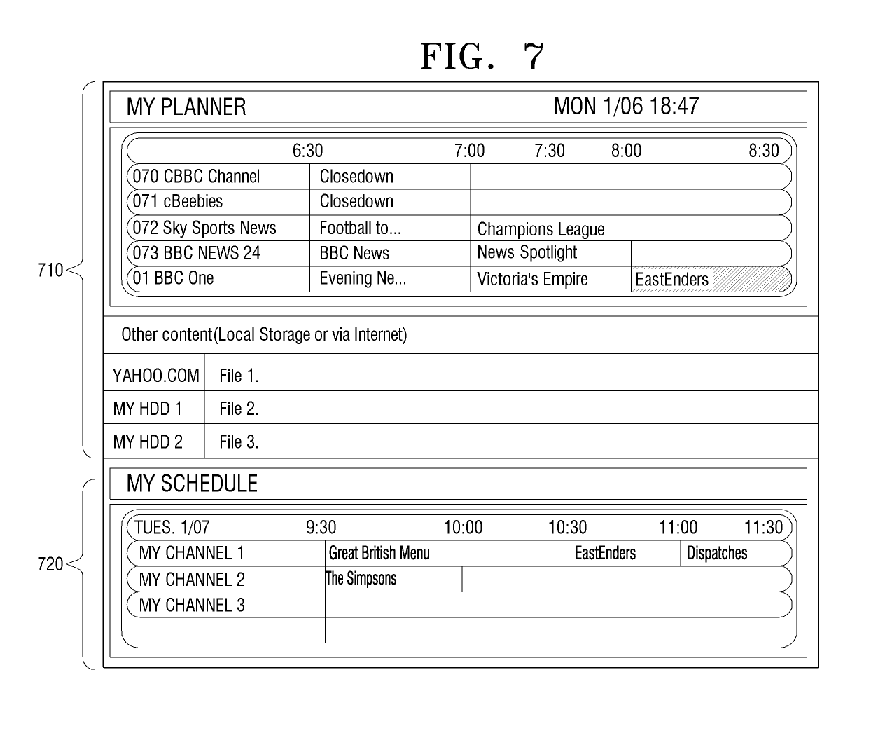

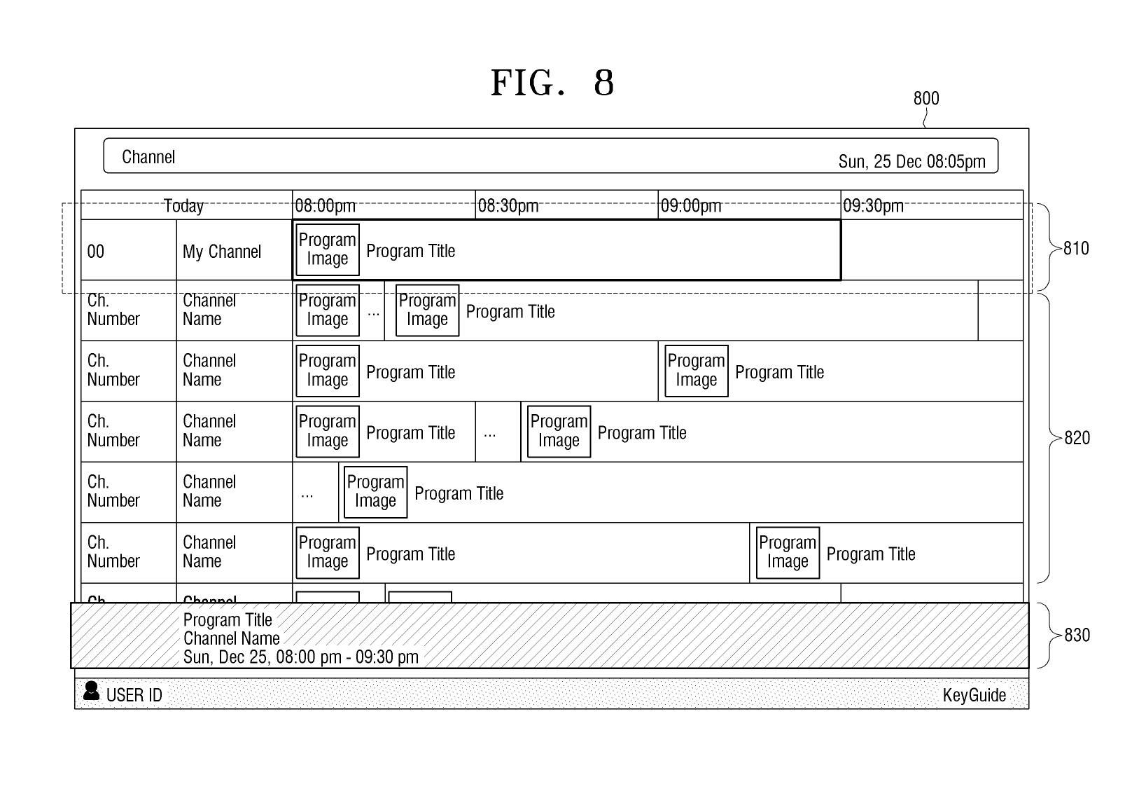

Meanwhile, according to an exemplary embodiment of the present disclosure, a multimedia content list and a sub-list may be displayed on one screen at the same time. Particularly, as in the FIG. 7, the controller 250 may display a multimedia content list 710 on an upper area of the display screen, and the sub-list 720 on a lower area of the display screen. However, the configuration of a screen shown in the FIG. 7 is merely an exemplary embodiment, and thus the multimedia content list 710 may be displayed on a left area of the display screen, and the sub-list 720 may be displayed on a right area of the display screen.

As aforementioned, if the multimedia content list 710 and the sub-list 720 are displayed at the same time, a user may generate the sub-list more easily and conveniently by using the multimedia content list 710. For example, if a touch panel is affixed to the TV 200, the controller 250 may touch a program to select from the multimedia content list, and if a user command of dragging the touched program to the sub-list is input, the controller 250 may perform an automatic reservation on the touched program.

Also, according to an exemplary embodiment of the present disclosure, a sub-list set by a user may be included in a broadcast program list and be displayed. In more detail, as shown in FIG. 8, the controller 250 may generate a broadcast program list 800 that contains “My Channel” area 810, broadcast program area 820, and information display area 830. In this case, “My Channel” area 810 is a channel area containing programs and contents that the user selected. Generally, the broadcast program area 820 is a broadcast channel area containing programs received from external broadcasting stations. The information display area 830 is an area that displays information of the highlighted programs and contents that a user selected.

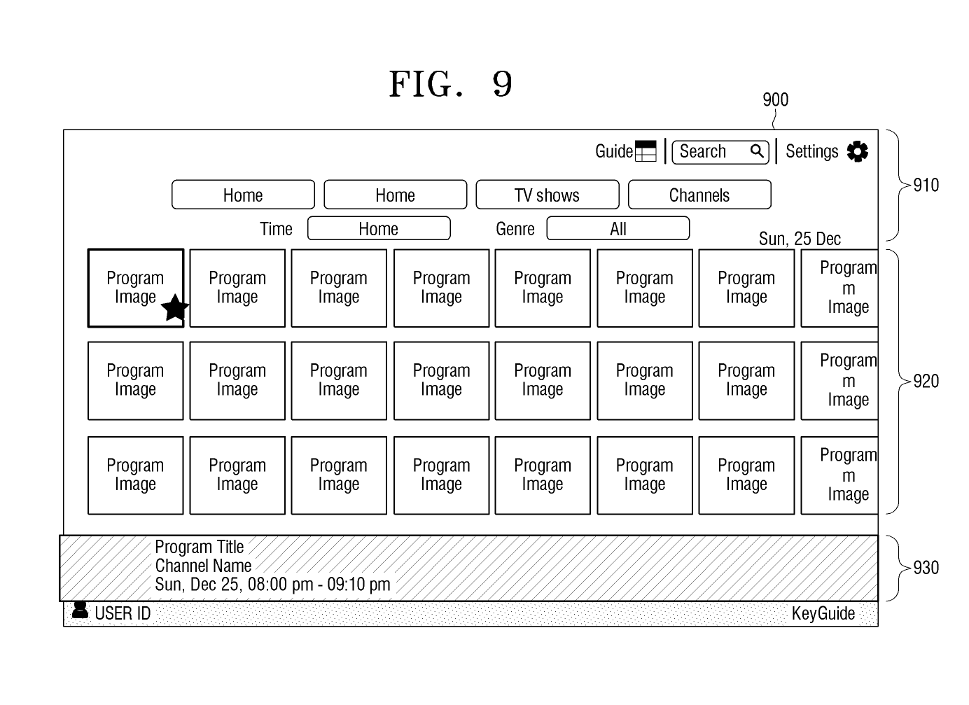

In addition, according to an exemplary embodiment of the present disclosure, a broadcast program list may display programs that playback at specific times in a form of an icon. For example, as shown in the FIG. 9, the controller 250 may generate a broadcast program list 900 that contains a program setting area 910, program icon area 920, and information displaying area 930. In this case, the program setting area 910 is an area for setting a program to be displayed on the program icon area 920, and a type, broadcasting time zone, and genre of the programs maybe set. The program icon area 920 is an area that displays programs set by the setting area 910 in the forms of icon, program information (for example, title) or thumbnail images may be displayed. In this case, the program icon area 920 may contain not only programs included in a general broadcast channel, but also programs and contents included in the sub-list. The information display area 930 is an area that displays information on programs and contents selected and highlighted by a user.

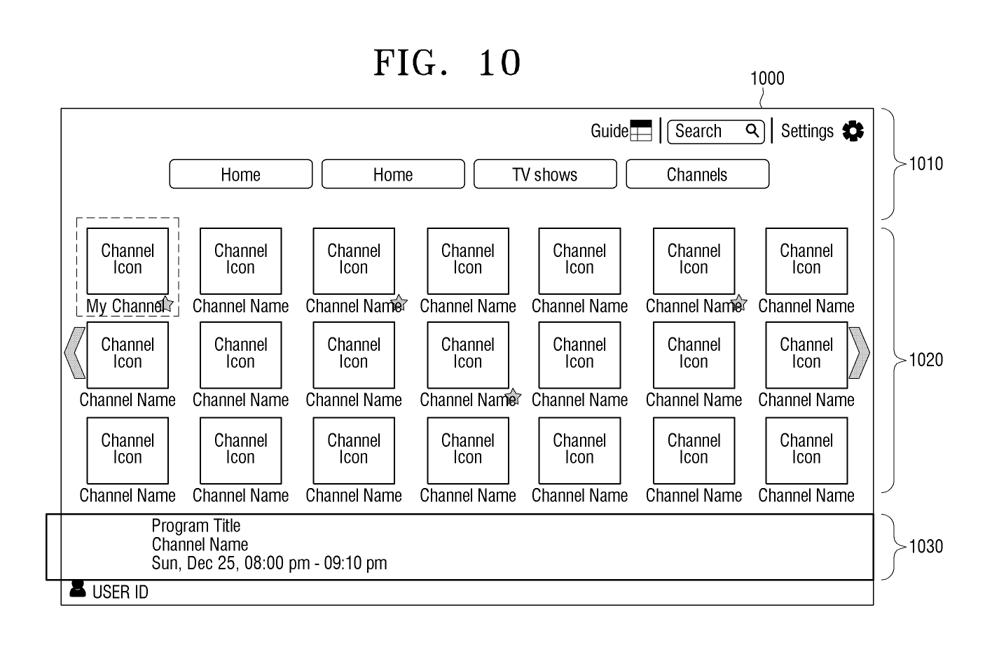

Further, according to an exemplary embodiment of the present disclosure, a broadcast program list may display channels in a form of an icon. For example, as shown in the FIG. 10, the controller 250 may generate a broadcast program list 1000 which includes a channel setting area 1010, channel icon area 1020 and information displaying area 1030. In this case, the channel setting area 1010 is an area for setting programs to be displayed on the channel icon area 1020, it may set type of channel etc. Channel icon area 1020 is an area which displays channels set by the channel setting area 1010 in a form of an icon, and it may display at least one of the channel titles, channel numbers, broadcasting program information (for example, title) and thumbnail images. In this case, the channel icon area 1020 may contain not only general broadcast channels, but also “My Channel” included in a sub-list. The information display area 1030 is an area that displays information on programs or contents that are currently broadcasted in the channel selected among the broadcast program list 1000 by a user.

As described above, the exemplary embodiments of the present invention provide a method of providing the multimedia content list of video files stored in the external device and broadcast programs, and the broadcast receiving apparatus using the method, so that the user may use TV multimedia content more conveniently.

Additionally, the exemplary embodiments of the present invention provide a method of providing the sub-list of the selected programs using the EPG information and the broadcast receiving apparatus using the method, so the user can view the selected programs with greater convenience.

Furthermore, the user may check both the broadcast program list and the video file list stored in the external device on a single screen, and it is thus possible to view video files stored in the external device more easily.

Moreover, the user may set the playback time of the recorded program files of programs scheduled for recording in advance, and accordingly, the user can view the recorded program files using his own channels.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method of providing a sub-list of a broadcast receiving apparatus, the method comprising:
displaying a video content list which contains a plurality of video contents and a sub-list, on a screen;
selecting at least one of the plurality of video contents contained in the video content list; and
adding the selected at least one video content to the sub-list and displaying it.

2. The method as claimed in claim 1, wherein the video content list comprises at least one of a broadcast program list generated using EPG information received from a broadcasting station, a video file list regarding video files stored in an internal storage medium or an external device connected, and a VOD file list regarding VOD files that are received from outside in real time.

3. The method as claimed in claim 2, wherein, if the selecting comprises setting a reservation playback time for the selected at least one video content by a user's input; further comprising playing back the at least one video content contained in the sub-list according to the set reservation playback time.

4. The method as claimed in claim 3, wherein, if the video content is a broadcast content, further comprising recording the selected broadcast content and storing in a record file; and the playing back plays back the record file of the broadcast content at the set reservation playback time.

5. The method as claimed in claim 3, wherein, if the video content is a VOD content, further comprising storing authentication information and route information of the selected VOD content; and
the playing back comprises:
receiving the VOD content based on the authentication information and route information of the VOD content at the set reservation playback time; and
playing back the received VOD content in real time.

6. The method as claimed in claim 3, wherein, if the video content list is a broadcast program list, the displaying maps the set reservation time of the sub-list with a broadcast time axis of the broadcast program list, and displays the sub-list and the broadcast program list on one screen.

7. The method as claimed in claim 1, wherein, if the broadcast receiving apparatus comprises a touch panel, the selecting selects at least one video content by a user command of touching a point where a video content to be added to the sub-list is displayed and dragging it to a point where the sub-list is displayed.

8. The method as claimed in claim 1, wherein, the sub-list differs according to an authenticated user, and
the displaying displays the video content list and the sub-list corresponding to the pre-designated user on one screen, if the pre-designated user is authenticated.

9. A broadcast receiving apparatus, comprising:
a display unit which displays a video content list which contains a plurality of video contents and a sub-list on one screen;
a user input unit; and
a controller which, if at least one of the plurality of video contents contained in the video content list is selected through the user input unit, controls the display unit to add the selected at least one video content to the sub-list and display it.

10. The apparatus as claimed in claim 9, wherein the video content list comprises at least one of a broadcast program list generated using EPG information received from a broadcasting station, a video file list regarding video files stored in an internal storage medium or an external device connected, and a VOD file list regarding VOD files that are received from outside in real time.

11. The apparatus as claimed in claim 10, wherein, if a reservation playback time regarding the selected at least one video content is set using the user input unit, the controller plays back the at least one video content contained in the sub-list according to the set reservation playback time.

12. The apparatus as claimed in claim 11, further comprising a storage unit,
wherein, when the video content is a broadcast content, the controller records the selected broadcast content and stores it in the storage unit as a record file, and plays back the record file of the broadcast content at the set reservation playback time.

13. The apparatus as claimed in claim 11, further comprising a storage unit,
wherein, if the video content is a VOD content, the controller stores authentication information and route information of the selected VOD content in the storage unit, and plays back the VOD content based on the authentication information and route information of the VOD content at the set reservation playback time.

14. The apparatus as claimed in claim 11, wherein, if the video content list is a broadcast program list, the display unit maps the set reservation time of the sub-list with a broadcast time axis of the broadcast program list, and displays the sub list and broadcast list on one screen.

15. The apparatus as claimed in claim 9, wherein, if the user input unit is a touch panel, the controller selects at least one video content by a user command of touching a point where a video content to be added to the sub-list and drags to the point where the sub list is displayed.

16. The apparatus as claimed in claim 9, wherein the sub list differs according to an authenticated user, and
if a pre-designated user is authenticated, the controller controls the display unit to display the video content list and the sub list corresponding to the predesignated user on one screen.

17. A method of providing a sub list comprising:
displaying a video content list which contains a plurality of video contents;
selecting at least one of the plurality of video contents contained in the video content list; and
displaying a sub-list where the selected at least one video content is contained,
wherein the video content list and the sub list are displayed on one screen.
